(19) United States
(12) Patent Application Publication
(10) Pub. No.: US 2022/0389928 A1
(43) Pub. Date: Dec. 8, 2022

(54) CROSSLINKED FLUORORESIN-COATED PUMP ROTOR MANUFACTURING METHOD, CROSSLINKED FLUORORESIN-COATED PUMP ROTOR, CROSSLINKED FLUORORESIN-COATED PUMP COVER MANUFACTURING METHOD, AND CROSSLINKED FLUORORESIN-COATED PUMP COVER

(71) Applicants: Sumitomo Electric Sintered Alloy, Ltd., Takahashi-shi, Okayama (JP); Sumitomo Electric Industries, Ltd., Osaka-shi, Osaka (JP)

(72) Inventors: Shoichi TAKADA, Takahashi-shi, Okayama (JP); Masato UOZUMI, Takahashi-shi, Okayama (JP); Makoto NAKABAYASHI, Osaka-shi, Osaka (JP); Eiichi KOBAYASHI, Osaka-shi, Osaka (JP); Kazuaki IKEDA, Osaka-shi, Osaka (JP)

(73) Assignees: Sumitomo Electric Sintered Alloy, Ltd., Takahashi-shi, Okayama (JP); Sumitomo Electric Industries, Ltd., Osaka-shi, Osaka (JP)

(21) Appl. No.: 17/774,144

(22) PCT Filed: Dec. 24, 2019
(86) PCT No.: PCT/JP2019/050638

§ 371 Date: May 4, 2022

(51) Int. Cl. F04C 15/00; C08L 27/12

(52) U.S. Cl. CPC F04C 15/00; C08L 27/12; F04C 2230/91; F04C 2240/20; C08L 2312/06

(57) ABSTRACT

A crosslinked fluororesin-coated pump rotor manufacturing method is a method for manufacturing a pump rotor having flat rotor side surfaces and provided with a coating layer of a crosslinked fluororesin on each rotor side surface, the method including: screen-printing a dispersion liquid obtained by dispersing particles of a fluororesin in a solvent, on the rotor side surface by using a screen plate having an opening having a shape in which the opening does not protrude from an outer peripheral edge of the rotor side surface; then heating the pump rotor to a temperature equal to or higher than a melting point of the fluororesin to bake the fluororesin on the rotor side surface; and then irradiating the fluororesin with radiation to crosslink the fluororesin.

### TECHNICAL FIELD

The present disclosure relates to a crosslinked fluororesin-coated pump rotor manufacturing method, a crosslinked fluororesin-coated pump rotor, a crosslinked fluororesin-coated pump cover manufacturing method, and a crosslinked fluororesin-coated pump cover.

### BACKGROUND ART

As a rotary pump which sucks and discharges fluid by rotating pump rotors, a pump described in PATENT LITERATURE 1 is known. The rotary pump of PATENT LITERATURE 1 includes a pump rotor having flat rotor side surfaces on both sides in the axial direction, a pump cover having a flat sliding guide surface which slides and guides the rotor side surface on one side in the axial direction, and a housing body having a flat sliding guide surface which slides and guides the rotor side surface on the other side in the axial direction.

Generally, a clearance (side clearance) for permitting rotation of the pump rotor is set between the rotor side surfaces and the sliding guide surfaces of the pump cover and the housing body. If the side clearance is large, the leak amount of fluid increases, decreasing the discharge amount of the pump. Thus, it is preferable that the side clearance is small. However, if the side clearance is made excessively small, there is a problem that seizure of the rotor side surfaces easily occurs. Therefore, the side clearance is usually set to a size of several tens of micrometers or more.

Here, the applicants of the present application have developed a rotary pump that allows the clearances between a pump rotor and a pump cover and a housing body to be set to be very small while preventing seizure of the pump rotor, and have proposed a pump of PATENT LITERATURE 2 as such a rotary pump.

In the rotary pump of PATENT LITERATURE 2, at least one of a pump rotor, a pump cover, and a housing body is coated with a crosslinked fluororesin. Since the crosslinked fluororesin has characteristics of having a low friction coefficient and high wear resistance, if at least one of the pump rotor, the pump cover, and the housing body is coated with the crosslinked fluororesin, even when the clearances between the pump rotor and the pump cover and the housing body are set to be very small, it is possible to prevent seizure of the pump rotor over a long period of time.

### CITATION LIST

### Patent Literature

PATENT LITERATURE 1: Japanese Laid-Open Patent Publication No. 2014-47751

PATENT LITERATURE 2: Japanese Laid-Open Patent Publication No. 2014-173513

### SUMMARY OF THE INVENTION

### Solution to Problem

A crosslinked fluororesin-coated pump rotor manufacturing method according to an aspect of the present disclosure is a crosslinked fluororesin-coated pump rotor manufacturing method for manufacturing a pump rotor having flat rotor side surfaces and provided with a coating layer of a crosslinked fluororesin on each rotor side surface, the method including:

screen-printing a dispersion liquid obtained by dispersing particles of a fluororesin in a solvent, on the rotor side surface by using a screen plate having an opening having a shape in which the opening does not protrude from an outer peripheral edge of the rotor side surface;

then heating the pump rotor to a temperature equal to or higher than a melting point of the fluororesin to bake the fluororesin on the rotor side surface; and

then irradiating the fluororesin with radiation to crosslink the fluororesin.

Moreover, a crosslinked fluororesin-coated pump cover manufacturing method according to an aspect of the present disclosure is a crosslinked fluororesin-coated pump cover manufacturing method for manufacturing a pump cover having a flat sliding guide surface for sliding and guiding a pump rotor and provided with a coating layer of a crosslinked fluororesin on the sliding guide surface, the method including:

screen-printing a dispersion liquid obtained by dispersing particles of a fluororesin in a solvent, on the sliding guide surface by using a screen plate having an opening having a shape in which the opening does not protrude from an outer peripheral edge of the sliding guide surface;

then heating the pump cover to a temperature equal to or higher than a melting point of the fluororesin to bake the fluororesin on the sliding guide surface; and

then irradiating the fluororesin with radiation to crosslink the fluororesin.

### BRIEF DESCRIPTION OF DRAWINGS

FIG. 1 is an exploded perspective view of a rotary pump, in which an outer rotor and an inner rotor obtained by a crosslinked fluororesin-coated pump rotor manufacturing method are used, according to a first embodiment of the present disclosure.

FIG. 2 is a front view of the rotary pump in FIG. 1.

FIG. 3 is a cross-sectional view taken along a line III-III in FIG. 2.

FIG. 4 is a cross-sectional view taken along a line IV-IV in FIG. 3.

FIG. 5 is an enlarged view of an area around the outer rotor and the inner rotor in FIG. 3.

FIG. 6 is a cross-sectional view taken along a line VI-VI in FIG. 2.

FIG. 7 is a diagram showing a screen plate used for manufacturing the inner rotor in FIG. 4.

FIG. 8A is a diagram showing a process of applying a dispersion liquid obtained by dispersing particles of a fluororesin in a solvent, to an inner rotor side surface by using the screen plate shown in FIG. 7, and is a diagram showing a state before an opening of the screen plate is filled with the dispersion liquid.

FIG. 8B is a diagram showing a state where the opening of the screen plate shown in FIG. 8A is filled with the dispersion liquid.

FIG. 8C is a diagram showing a process of transferring the dispersion liquid from the opening of the screen plate shown in FIG. 8B to the inner rotor side surface.

FIG. 8D is a diagram showing a state after the dispersion liquid is transferred from the opening of the screen plate shown in FIG. 8C to the inner rotor side surface.

FIG. 9 is a diagram showing a modification of the screen plate shown in FIG. 7.

FIG. 10 is an enlarged view showing a cross-section of a crosslinked fluororesin film formed by using the screen plate shown in FIG. 7.

FIG. 11 is an enlarged view showing a cross-section of a crosslinked fluororesin film formed by using the screen plate shown in FIG. 9.

FIG. 12 is an enlarged view showing a cross-section of a crosslinked fluororesin film formed by using the screen plate shown in FIG. 9 after an oil-impregnated plastic layer is provided on the inner rotor side surface in advance.

FIG. 13 is an exploded perspective view of a rotary pump, in which pump covers obtained by a crosslinked fluororesin-coated pump cover manufacturing method are used, according to a second embodiment of the present disclosure.

FIG. 14 is a diagram showing a rotary pump, in which a pump rotor obtained by a crosslinked fluororesin-coated pump rotor manufacturing method is used, according to a third embodiment of the present disclosure, correspondingly to FIG. 4.

FIG. 15 is a cross-sectional view taken along a line XV-XV in FIG. 14.

FIG. 16 is an enlarged view of an area around the pump rotor in FIG. 15.

### DETAILED DESCRIPTION

### [Problems to be Solved by the Present Disclosure]

The inventors of the present application have conducted in-house development of a rotary pump in which at least one of a pump rotor, a pump cover, and a housing body is coated with a crosslinked fluororesin as in PATENT LITERATURE 2, and have studied mass production of a pump in which a pump rotor is coated with a crosslinked fluororesin, as such a rotary pump.

Here, when coating a pump rotor with a crosslinked fluororesin, it is considered to coat the entirety of the surface (rotor side surfaces, an outer peripheral surface of the pump rotor, an inner peripheral surface of the pump rotor, etc.) of the pump rotor.

However, when coating the outer peripheral surface and the inner peripheral surface of the pump rotor with the crosslinked fluororesin, since the outer peripheral surface and the inner peripheral surface of the pump rotor are curved surfaces in general, it is difficult to accurately manage the thickness of the crosslinked fluororesin. Therefore, it is difficult to accurately manage the dimensions of the outer peripheral surface and the inner peripheral surface of the pump rotor, thus facing a problem that the pump performance becomes unstable.

Therefore, the inventors have studied, in order to allow the dimensions of the outer peripheral surface and the inner peripheral surface of the pump rotor to be accurately managed even when the pump rotor is coated with the crosslinked fluororesin, masking the surface other than the rotor side surfaces (the outer peripheral surface and the inner peripheral surface of the pump rotor, etc.) with masking tape or the like when applying a dispersion liquid obtained by dispersing particles of a fluororesin in a solvent to the pump rotor by a method such as spraying or dipping (immersion), and applying the dispersion liquid to the rotor side surfaces in this state. By doing so, since a coating layer is not formed on the inner peripheral surface and the outer peripheral surface of the pump rotor when forming a coating layer of the crosslinked fluororesin on the rotor side surfaces, it is possible to accurately manage the dimensions of the outer peripheral surface and the inner peripheral surface of the pump rotor.

However, the work of masking the inner peripheral surface and the outer peripheral surface of the pump rotor is complicated. In addition, when the pump rotor is coated with the crosslinked fluororesin by spraying, dipping (immersion), or the like which is a general coating method, in order to make the thickness of the coating layer of the crosslinked fluororesin uniform, it is necessary to grind or polish the crosslinked fluororesin, and the processing cost is high. Also, when a sliding guide surface of a pump cover is coated with the crosslinked fluororesin, the same problem as described above arises.

Therefore, an object of the present disclosure is to allow a pump rotor or a pump cover, of a rotary pump, which can prevent seizure of the pump rotor over a long period of time and has stable performance, to be manufactured at low cost.

### [Effects of the Present Disclosure]

According to the present disclosure, it is possible to manufacture a pump rotor or a pump cover, of a rotary pump, which can prevent seizure of the pump rotor over a long period of time and has stable performance, to be manufactured at low cost.

### [Description of Embodiments of the Present Disclosure]

(1) A crosslinked fluororesin-coated pump rotor manufacturing method according to an aspect of the present disclosure is a crosslinked fluororesin-coated pump rotor manufacturing method for manufacturing a pump rotor having flat rotor side surfaces and provided with a coating layer of a crosslinked fluororesin on each rotor side surface, the method including:

screen-printing a dispersion liquid obtained by dispersing particles of a fluororesin in a solvent, on the rotor side surface by using a screen plate having an opening having a shape in which the opening does not protrude from an outer peripheral edge of the rotor side surface;

then heating the pump rotor to a temperature equal to or higher than a melting point of the fluororesin to bake the fluororesin on the rotor side surface; and

then irradiating the fluororesin with radiation to crosslink the fluororesin.

By doing so, since the rotor side surfaces of the pump rotor are coated with the crosslinked fluororesin, even when the side clearance of the pump rotor is set to be very small, it is possible to prevent seizure of the pump rotor over a long period of time.

Since the dispersion liquid obtained by dispersing particles of the fluororesin in the solvent is screen-printed by using the screen plate having the opening having a shape in which the opening does not protrude from the outer peripheral edge of the rotor side surface, the dispersion liquid obtained by dispersing particles of the fluororesin in the solvent can be applied to the rotor side surface without masking, so that the application work is easy. In addition, since the method for applying the dispersion liquid obtained by dispersing particles of the fluororesin in the solvent is screen-printing, a coating layer of the crosslinked fluororesin having a uniform thickness can be obtained without grinding or polishing the crosslinked fluororesin, so that the cost is low.

(2) Preferably, a plurality of through holes for holding oil are formed in the coating layer of the crosslinked fluororesin by using a plate in which a plurality of non-printing regions for blocking permeation of the dispersion liquid are provided inside the opening, as the screen plate.

By doing so, since lubricating oil is held in the plurality of through holes of the coating layer of the crosslinked fluororesin, the friction reduction effect by the crosslinked fluororesin and the lubrication effect by the lubricating oil are synergistically exerted, so that it is possible to significantly and effectively reduce the frictional resistance of the rotor side surface.

(3) Preferably, an oil-impregnated plastic layer is exposed through the through holes by providing the oil-impregnated plastic layer on the rotor side surface in advance before screen-printing the dispersion liquid on the rotor side surface.

By doing so, since the oil-impregnated plastic layer has high lipophilicity, it is possible to very effectively hold the lubricating oil in the through holes of the coating layer of the crosslinked fluororesin.

(4) Moreover, the present disclosure also provides the following as a crosslinked fluororesin-coated pump rotor produced by the above manufacturing method.

A crosslinked fluororesin-coated pump rotor having flat rotor side surfaces and provided with a coating layer of a crosslinked fluororesin on each rotor side surface, wherein

a plurality of through holes for holding oil are formed in the coating layer of the crosslinked fluororesin.

(5) An oil-impregnated plastic layer can be provided as a base for the coating layer of the crosslinked fluororesin and exposed through the through holes.

(6) A crosslinked fluororesin-coated pump cover manufacturing method according to an aspect of the present disclosure is a crosslinked fluororesin-coated pump cover manufacturing method for manufacturing a pump cover having a flat sliding guide surface for sliding and guiding a pump rotor and provided with a coating layer of a crosslinked fluororesin on the sliding guide surface, the method including:

screen-printing a dispersion liquid obtained by dispersing particles of a fluororesin in a solvent, on the sliding guide surface by using a screen plate having an opening having a shape in which the opening does not protrude from an outer peripheral edge of the sliding guide surface;

then heating the pump cover to a temperature equal to or higher than a melting point of the fluororesin to bake the fluororesin on the sliding guide surface; and

then irradiating the fluororesin with radiation to crosslink the fluororesin.

By doing so, since the sliding guide surface for sliding and guiding a pump rotor is coated with the crosslinked fluororesin, even when the side clearance of the pump rotor is set to be very small, it is possible to prevent seizure of the pump rotor over a long period of time.

Since the dispersion liquid obtained by dispersing particles of the fluororesin in the solvent is screen-printed by using the screen plate having the opening having a shape in which the opening does not protrude from the outer peripheral edge of the sliding guide surface, the dispersion liquid obtained by dispersing particles of the fluororesin in the solvent can be applied to the sliding guide surface without masking, so that the application work is easy. In addition, since the method for applying the dispersion liquid obtained by dispersing particles of the fluororesin in the solvent is screen-printing, a coating layer of the crosslinked fluororesin having a uniform thickness can be obtained without grinding or polishing the crosslinked fluororesin, so that the cost is low.

(7) Preferably, a plurality of through holes for holding oil are formed in the coating layer of the crosslinked fluororesin by using a plate in which a plurality of non-printing regions for blocking permeation of the dispersion liquid are provided inside the opening, as the screen plate.

By doing so, since lubricating oil is held in the plurality of through holes of the coating layer of the crosslinked fluororesin, the friction reduction effect by the crosslinked fluororesin and the lubrication effect by the lubricating oil are synergistically exerted, so that it is possible to significantly and effectively reduce the frictional resistance of the sliding guide surface.

(8) Preferably, an oil-impregnated plastic layer is exposed through the through holes by providing the oil-impregnated plastic layer on the sliding guide surface in advance before screen-printing the dispersion liquid on the sliding guide surface.

By doing so, since the oil-impregnated plastic layer has high lipophilicity, it is possible to very effectively hold the lubricating oil in the through holes of the coating layer of the crosslinked fluororesin.

(9) Moreover, the present disclosure also provides the following as a crosslinked fluororesin-coated pump cover produced by the above manufacturing method.

A crosslinked fluororesin-coated pump cover having a flat sliding guide surface for sliding and guiding a pump rotor and provided with a coating layer of a crosslinked fluororesin on the sliding guide surface, wherein a plurality of through holes for holding oil are formed in the coating layer of the crosslinked fluororesin.

(10) An oil-impregnated plastic layer can be provided as a base for the coating layer of the crosslinked fluororesin and exposed through the through holes.

### [Details of Embodiments of the Present Disclosure]

Hereinafter, specific examples of a crosslinked fluororesin-coated pump rotor manufacturing method and a crosslinked fluororesin-coated pump cover manufacturing method according to embodiments of the present disclosure will be described with reference to the drawings. The present invention is not limited to these examples and is indicated by the claims, and is intended to include meaning equivalent to the claims and all modifications within the scope of the claims.

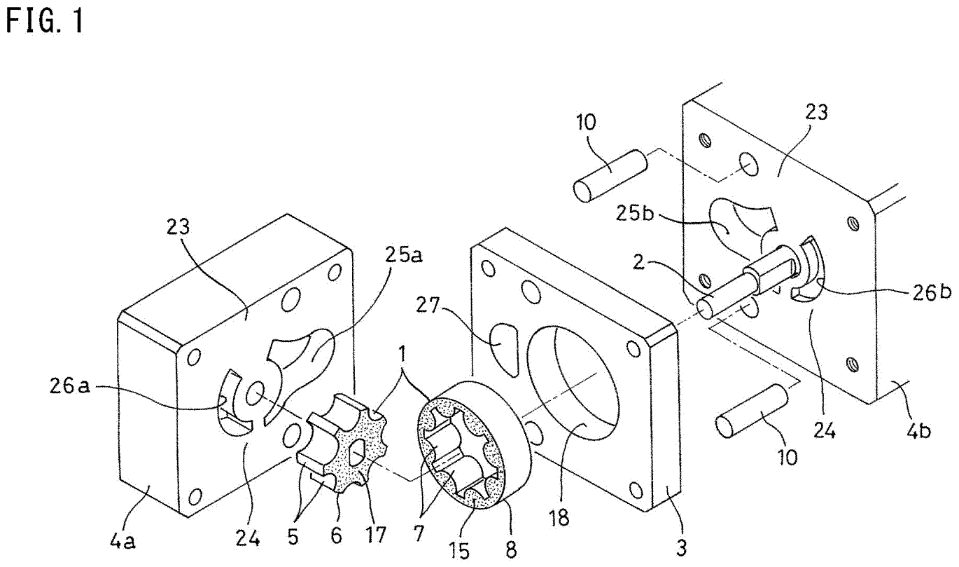

FIG. 1 to FIG. 6 show a rotary pump, in which a pump rotor 1 obtained by a crosslinked fluororesin-coated pump rotor manufacturing method is used, according to a first embodiment of the present disclosure. The rotary pump includes the pump rotor 1 which is rotationally driven by a rotation shaft 2, a housing body 3 in which the pump rotor 1 is housed, a first pump cover 4a which is disposed on one side in the axial direction (the left side in the drawing) of the housing body 3, and a second pump cover 4b which is disposed on the other side in the axial direction (the right side in the drawing) of the housing body 3.

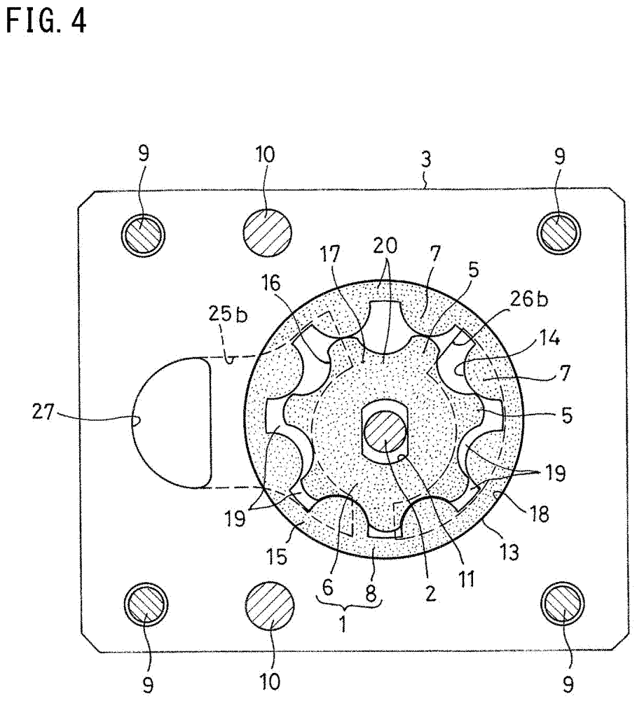

As shown in FIG. 1 and FIG. 4, the pump rotor 1 includes an inner rotor 6 having a plurality of external teeth 5 on the outer periphery thereof, and an annular outer rotor 8 having a plurality of internal teeth 7, which mesh with the external teeth 5, on the inner periphery thereof.

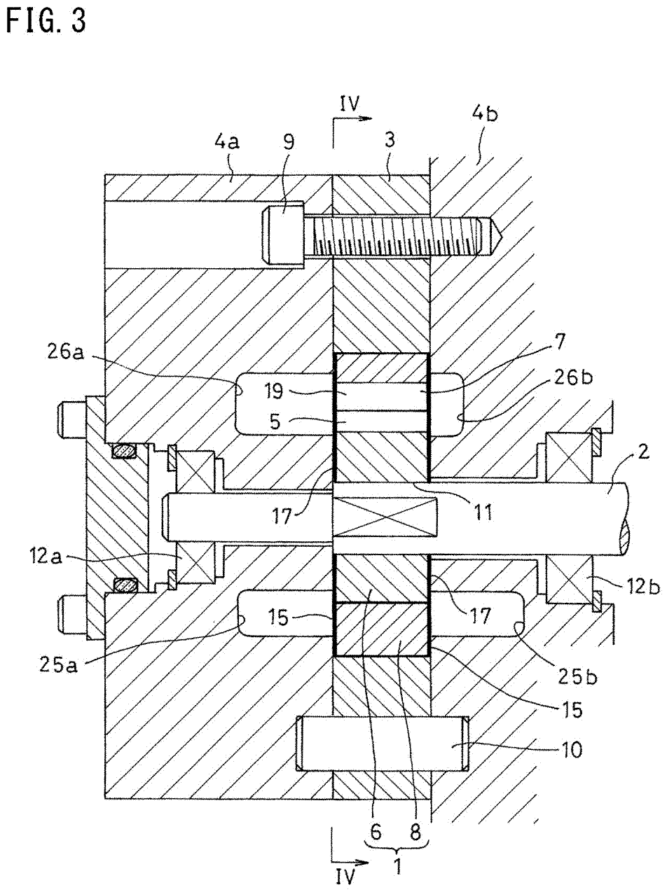

As shown in FIG. 3, the housing body 3 is formed in a hollow tubular shape surrounding the outer periphery of the outer rotor 8. The first pump cover 4a, the housing body 3, and the second pump cover 4b are fixed to each other by being tightened in the axial direction with bolts 9. In addition, the first pump cover 4a, the housing body 3, and the second pump cover 4b are positioned by knock pins 10 in a direction perpendicular to the axis.

In the inner rotor 6, a shaft hole 11 into which the rotation shaft 2 is inserted is formed. The rotation shaft 2 is a shaft body which rotationally drives the inner rotor 6, and is connected to a rotary drive device (electric motor or the like) which is not shown. The rotation shaft 2 and the shaft hole 11 are fitted to each other such that the rotation shaft 2 and the inner rotor 6 rotate integrally. In addition to the width-across-flat fitting as shown in the drawing, spline fitting, keyway fitting, and fitting with an interference between cylindrical surfaces (shrinkage fitting or press fitting) may be adopted for fitting the rotation shaft 2 and the shaft hole 11.

The shaft hole 11 of the inner rotor 6 is a through hole which penetrates the inner rotor 6 in the axial direction. The rotation shaft 2 is inserted into the shaft hole 11 so as to have a portion protruding on one side in the axial direction (the left side in the drawing) from the inner rotor 6 and a portion protruding on the other side in the axial direction (the right side in the drawing) from the inner rotor 6. The portion, of the rotation shaft 2, protruding on the one side in the axial direction from the inner rotor 6 is rotatably supported by a first bearing 12a mounted on the first pump cover 4a, and the portion, of the rotation shaft 2, protruding on the other side in the axial direction from the inner rotor 6 is rotatably supported by a second bearing 12b mounted on the second pump cover 4b.

As shown in FIG. 4, the outer rotor 8 is an annular member which has a cylindrical outer peripheral surface 13, an inner peripheral surface 14 forming the plurality of internal teeth 7, and flat outer rotor side surfaces 15 (see FIG. 3) orthogonal to the axial direction. The inner rotor 6 is a member which has an outer peripheral surface 16 forming the plurality of external teeth 5 which mesh with the internal teeth 7 of the outer rotor 8, and flat inner rotor side surfaces 17 (see FIG. 3) orthogonal to the axial direction.

The outer peripheral surface 13 of the outer rotor 8 is fitted to a cylindrical inner peripheral surface 18 of the housing body 3 with a gap therebetween, and the outer rotor 8 is rotatably supported by the fitting. Here, the outer rotor 8 is supported so as to be rotatable about a position eccentric from the center position of the inner rotor 6 (that is, the rotation center position of the rotation shaft 2). When the inner rotor 6 is rotated, the outer rotor 8 rotates together with the inner rotor 6 due to the meshing of the internal teeth 7 and the external teeth 5. The rotation direction of the inner rotor 6 is the clockwise direction in the drawing.

The number of internal teeth 7 of the outer rotor 8 is larger than the number of external teeth 5 of the inner rotor 6 by one. The outer peripheral surface 16 of the inner rotor 6 is a curved surface obtained as a trajectory by translating, in the axial direction, a toothed curve of the external teeth 5 (for example, a toothed curve in which curves that are radially outwardly curved in a convex shape and curves that are radially inwardly curved in a concave shape are alternately aligned along the circumferential direction, such as a trochoid curve and a cycloid curve). The inner peripheral surface 14 of the outer rotor 8 is also a curved surface obtained as a trajectory by translating, in the axial direction, a toothed curve of the internal teeth 7 (for example, a toothed curve in which curves that are radially outwardly curved in a convex shape and curves that are radially inwardly curved in a concave shape are alternately aligned along the circumferential direction, such as a trochoid curve, a cycloid curve, or an envelope curve of a toothed curve of the inner rotor 6).

A plurality of chambers 19 (spaces for containing fluid) defined by the respective external teeth 5 and the respective internal teeth 7 are formed between the outer peripheral surface 16 of the inner rotor 6 and the inner peripheral surface 14 of the outer rotor 8. Here, the plurality of chambers 19 are formed such that the volumes thereof change as the inner rotor 6 and the outer rotor 8 rotate. That is, the volume of each chamber 19 is maximized at an angular position at which the center of the inner rotor 6 and the center of the outer rotor 8 are farthest from each other (at the upper position in the drawing), and decreases as the chamber 19 comes closer to an angular position at which the center of the inner rotor 6 and the center of the outer rotor 8 are closest to each other (at the lower position in the drawing). Therefore, when the inner rotor 6 and the outer rotor 8 rotate, fluid discharge action occurs on a side through which movement is made from the angular position at which the center of the inner rotor 6 and the center of the outer rotor 8 are farthest from each other to the angular position at which the center of the inner rotor 6 and the center of the outer rotor 8 are closest to each other (on the right side in the drawing), due to reduction of the volumes of the chambers 19. On the other hand, fluid suction action occurs on a side through which movement is made from the angular position at which the center of the inner rotor 6 and the center of the outer rotor 8 are closest to each other to the angular position at which the center of the inner rotor 6 and the center of the outer rotor 8 are farthest from each other (on the left side in the drawing), due to gradual increase of the volumes of the chambers 19.

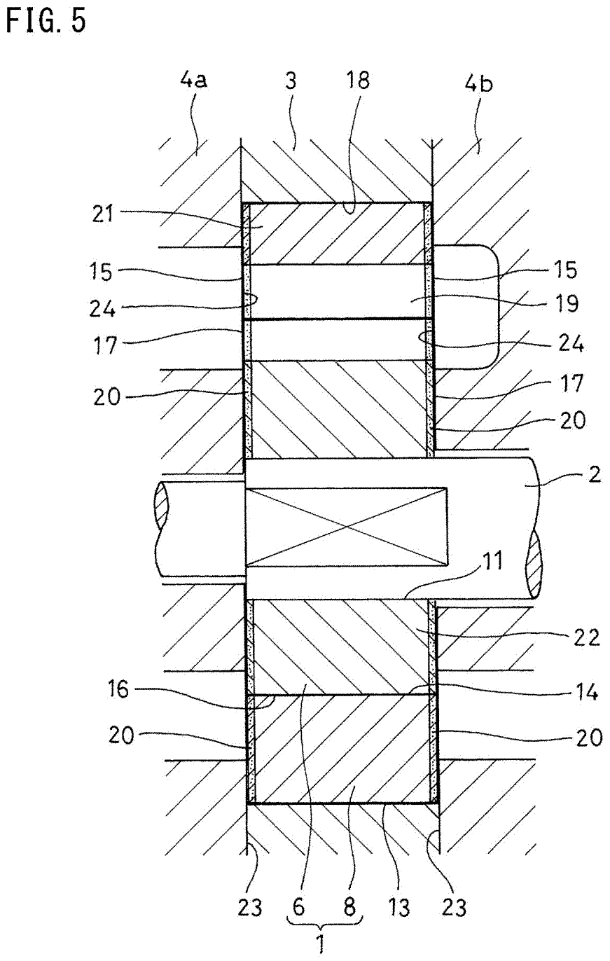

As shown in FIG. 5, the outer rotor side surfaces 15 are a pair of flat surfaces which are formed on both sides in the axial direction of the outer rotor 8 so as to face opposite to each other in the axial direction. The inner rotor side surfaces 17 are a pair of flat surfaces which are formed on both sides in the axial direction of the inner rotor 6 so as to face opposite to each other in the axial direction.

A coating layer of a crosslinked fluororesin 20 is provided on the outer rotor side surfaces 15. On the other hand, the inner peripheral surface 14 and the outer peripheral surface 13 of the outer rotor 8 are surfaces not coated with the crosslinked fluororesin 20 (metal surfaces). Here, the outer rotor 8 includes a sintered metal body 21 and a coating layer of the crosslinked fluororesin 20 provided so as to coat the surface of the sintered metal body 21, and the surface of the coating layer forms the outer rotor side surfaces 15. The sintered metal body 21 is formed by heating a powder compact, which is obtained by compression-molding an iron-based powder material with a mold, at a high temperature equal to or lower than the melting point of the material.

The crosslinked fluororesin 20 is obtained by crosslinking molecules of a chain polymer forming a fluororesin, and has a low friction coefficient equivalent to that of a general fluororesin (non-crosslinked fluororesin) but has wear resistance that is much higher than that of a general fluororesin.

As the fluororesin to be crosslinked, polytetrafluoroethylene (PTFE), tetrafluoroethylene-hexafluoropropylene copolymer (FEP), tetrafluoroethylene-perfluoroalkyl vinyl ether copolymer (PFA), and the like can be adopted. As the crosslinked fluororesin 20, crosslinked PTFE is preferably adopted. When crosslinked PTFE is adopted, since the crosslinked PTFE has a particularly low friction coefficient among the above fluororesins and has excellent wear resistance, almost no wear occurs, so that it is possible to effectively increase the pump efficiency.

Similarly, a coating layer of the crosslinked fluororesin 20 is also provided on the inner rotor side surfaces 17. On the other hand, the outer peripheral surface 16 of the inner rotor 6 and the inner surface of the shaft hole 11 are surfaces not coated with the crosslinked fluororesin 20 (metal surfaces). Here, the inner rotor 6 includes a sintered metal body 22 and a coating layer of the crosslinked fluororesin 20 provided so as to coat the surface of the sintered metal body 22, and the surface of the coating layer forms the inner rotor side surfaces 17.

The width dimension between the pair of the outer rotor side surfaces 15 is equal to the width dimension between the pair of the inner rotor side surfaces 17. The outer rotor side surface 15 on one side in the axial direction (the left side in the drawing) is located on the same plane as the inner rotor side surface 17 on the one side in the axial direction (the left side in the drawing), and the outer rotor side surface 15 on the other side in the axial direction (the right side in the drawing) is located on the same plane as the inner rotor side surface 17 on the other side in the axial direction (the right side in the drawing).

The first pump cover 4a has a flat mating surface 23 which is brought into contact with and fixed to the side surface on the one side in the axial direction of the housing body 3, and a flat sliding guide surface 24 which slides and guides the outer rotor side surface 15 on the one side in the axial direction and the inner rotor side surface 17 on the one side in the axial direction. The second pump cover 4b also has a flat mating surface 23 which is brought into contact with and fixed to the side surface on the other side in the axial direction of the housing body 3, and a flat sliding guide surface 24 which slides and guides the outer rotor side surface 15 on the other side in the axial direction and the inner rotor side surface 17 on the other side in the axial direction. The sliding guide surfaces 24 are each a finished surface having a surface roughness of Ra 1.6 μm or less (preferably Ra 0.8 μm or less).

The gap between the outer rotor side surfaces 15 and the housing body 3 (that is, the difference between the width dimension between the pair of the outer rotor side surfaces 15 and the inner width dimension between a pair of the sliding guide surfaces 24, facing each other in the axial direction, of the housing body 3) is set so as to be not greater than 20 μm (preferably not greater than 15 μm, more preferably not greater than 10 μm). Similarly, the gap between the inner rotor side surfaces 17 and the housing body 3 (that is, the difference between the width dimension between the pair of the inner rotor side surfaces 17 and the inner width dimension between the pair of the sliding guide surfaces 24, facing each other in the axial direction, of the housing body 3) is also set so as to be not greater than 20 μm (preferably not greater than 15 μm, more preferably not greater than 10 μm).

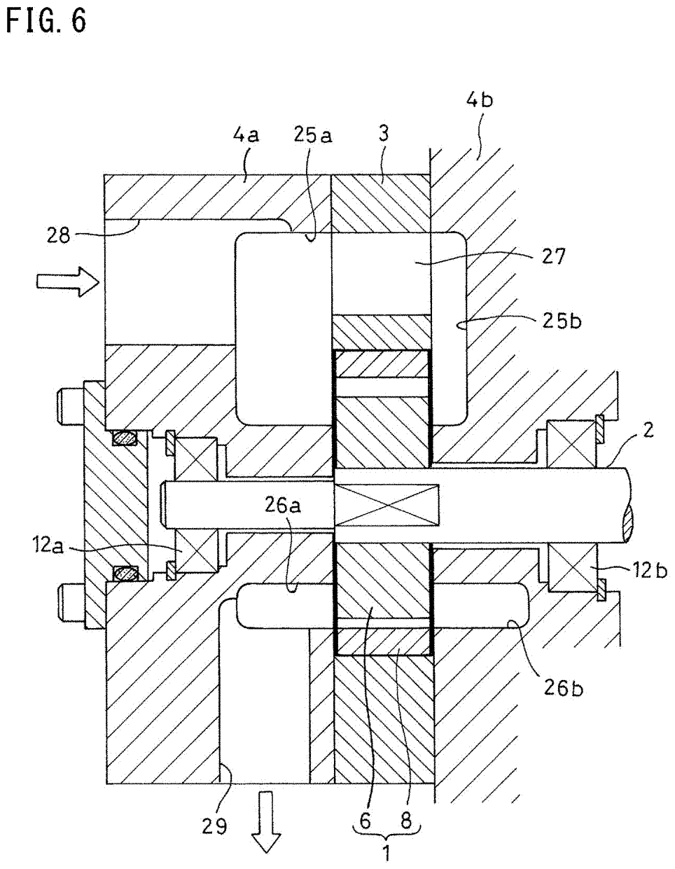

As shown in FIG. 6, a first suction port 25a and a first discharge port 26a are open in the first pump cover 4a. In addition, a second suction port 25b and a second discharge port 26b are also open in the second pump cover 4b.

The first suction port 25a and the second suction port 25b are open in the same shape at symmetrical positions with the inner rotor 6 and the outer rotor 8 therebetween. Accordingly, the pressure received by the inner rotor 6 and the outer rotor 8 from fluid in the first suction port 25a and the pressure received by the inner rotor 6 and the outer rotor 8 from fluid in the second suction port 25b are balanced to prevent the inner rotor 6 and the outer rotor 8 from being tilted.

Similarly, the first discharge port 26a and the second discharge port 26b are also open in the same shape at symmetrical positions with the pump rotor 1 therebetween. Accordingly, the pressure received by the inner rotor 6 and the outer rotor 8 from fluid in the first discharge port 26a and the pressure received by the inner rotor 6 and the outer rotor 8 from fluid in the second discharge port 26b are balanced to prevent the inner rotor 6 and the outer rotor 8 from being tilted.

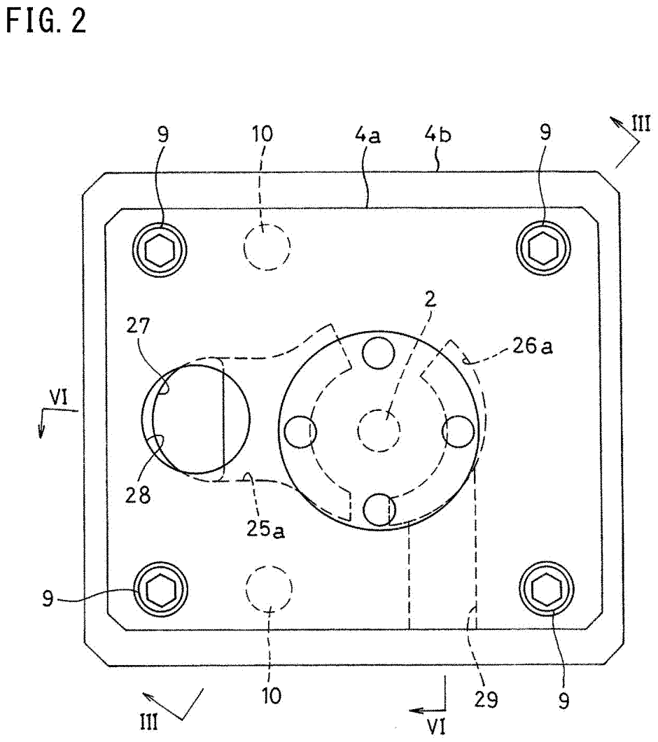

As shown in FIG. 4 and FIG. 6, the first suction port 25a and the second suction port 25b communicate with each other through a communication passage 27 which is formed in the housing body 3. In addition, as shown in FIG. 2 and FIG. 6, the first suction port 25a communicates with a suction port 28 which is open on the outer surface of the first pump cover 4a, and the first discharge port 26a communicates with a discharge port 29 which is open on the outer surface of the first pump cover 4a.

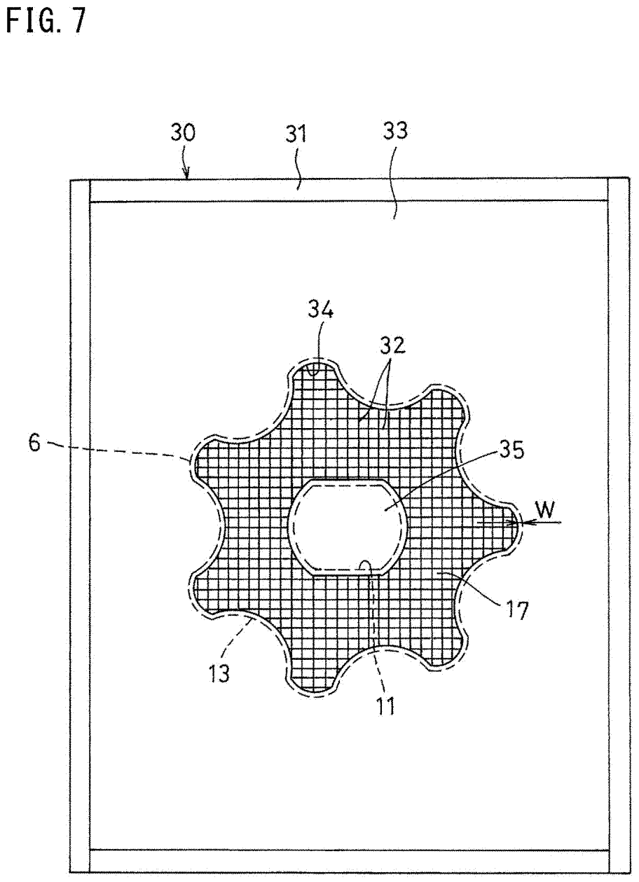

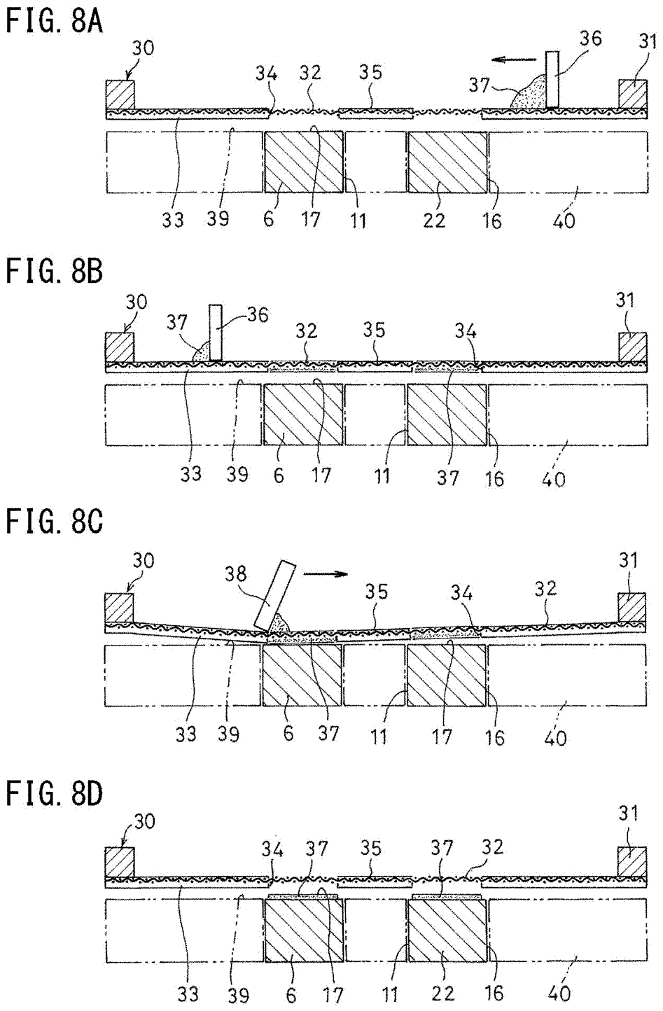

A method for manufacturing the inner rotor 6 in which the coating layer of the crosslinked fluororesin 20 is provided on each inner rotor side surface 17 will be described with reference to FIG. 7 and FIG. 8A to FIG. 8D.

As shown in FIG. 7 and FIG. 8A, a screen plate 30 is placed parallel to the inner rotor side surface 17 before coating, with a gap therebetween. The screen plate 30 includes a frame body 31, a screen mesh 32 stretched inside the frame body 31, and a mask portion 33 formed by closing the spacing of the screen mesh 32. As the screen mesh 32, for example, a mesh formed by weaving yarns having a yarn diameter of 100 μm or less with a gap between adjacent yarns can be used. As the mask portion 33, one obtained by irradiating and curing a photosensitive emulsion, which is applied to the screen mesh 32, with ultraviolet rays, can be used.

As shown in FIG. 7, the mask portion 33 has an opening 34 having a shape in which the opening 34 does not protrude from the outer peripheral edge (outer peripheral surface 16) of the inner rotor 6 to the radially outer side. The opening 34 is a region where the screen mesh 32 is exposed. The contour of the opening 34 is a curve having a shape obtained by offsetting the outer peripheral surface 16 of the inner rotor 6 to the radially inner side. The contour of the opening 34 is formed such that a width w of a band-shaped region where the mask portion 33 overlaps the inner rotor side surface 17 is not greater than 1 mm (preferably not greater than 0.5 mm). In addition, a mask portion 35 corresponding to the shaft hole 11 of the inner rotor 6 is also formed in the screen plate 30. The outer periphery of the mask portion 35 is a curve having a shape obtained by offsetting the end opening of the shaft hole 11 to the radially outer side.

As shown in FIG. 8A and FIG. 8B, a scraper 36 is moved along the surface of the screen plate 30 to fill the inside of the opening 34 with a dispersion liquid 37 obtained by dispersing particles of a fluororesin in a solvent (for example, water). Next, as shown in FIG. 8C and FIG. 8D, the screen plate 30 is moved while being pressed against the inner rotor side surface 17 with a squeegee 38, thereby transferring the dispersion liquid 37 to the inner rotor side surface 17. At this time, a jig 40 having an auxiliary surface 39 which is formed so as to be located on the same plane as the inner rotor side surface 17 can be used. The jig 40 is a member having an inner peripheral shape that fits to the outer peripheral surface 16 of the inner rotor 6.

After the dispersion liquid 37 is screen-printed on the inner rotor side surface 17 as described, the printed dispersion liquid 37 is dried, whereby a coating layer of the fine particles of the uncrosslinked fluororesin is formed on the inner rotor side surface 17. Thereafter, the inner rotor 6 is heated to a temperature equal to or higher than the melting point of the fluororesin, thereby baking the fine particles of the uncrosslinked fluororesin with which the inner rotor side surface 17 has been coated, to fuse the fine particles of the fluororesin.

Thereafter, the fluororesin on the inner rotor side surface 17 is crosslinked by irradiating the inner rotor side surface 17 with radiation. Specifically, the inner rotor 6 is placed in an oxygen-free atmosphere having a predetermined high temperature, and radiation (for example, electron beam) is applied toward the inner rotor side surface 17, thereby forming covalent bonds between molecules of a chain polymer forming the fluororesin, to crosslink the molecules of the chain polymer. In addition, chemical bonds are also formed between the inner rotor 6 and the molecules of the chain polymer forming the fluororesin, by the radiation applied at this time, and the adhesion of the crosslinked fluororesin 20 becomes very high through the chemical bonds.

As described above, the inner rotor 6 in which the coating layer of the crosslinked fluororesin 20 is provided on each inner rotor side surface 17 can be manufactured.

Also, the outer rotor 8 in which the coating layer of the crosslinked fluororesin 20 is provided on each outer rotor side surface 15 can be manufactured in the same manner as the above-described inner rotor 6. That is, the outer rotor 8 can be manufactured by screen-printing the dispersion liquid 37 obtained by dispersing particles of the fluororesin in the solvent, on the outer rotor side surface 15 by using a screen plate 30 having an opening 34 having a shape in which the opening 34 does not protrude from the outer peripheral edge of the outer rotor side surface 15 (the outer peripheral surface 13) to the radially outer side and does not protrude from the inner peripheral edge (the inner peripheral surface 14) of the outer rotor side surface 15 to the radially inner side, then heating the outer rotor 8 to a temperature equal to or higher than the melting point of the fluororesin to bake the fluororesin on the outer rotor side surface 15, and then irradiating the fluororesin with radiation to crosslink the fluororesin.

When the inner rotor 6 and the outer rotor 8 are manufactured as in the above embodiment, since the inner rotor side surfaces 17 and the outer rotor side surfaces 15 are coated with the crosslinked fluororesin 20, even when the side clearances of the inner rotor 6 and the outer rotor 8 are set to be very small, it is possible to prevent seizure of the inner rotor 6 and the outer rotor 8 over a long period of time.

Since the dispersion liquid 37 obtained by dispersing particles of the fluororesin in the solvent is screen-printed by using the screen plates 30 having the openings 34 each having a shape in which the opening 34 does not protrude from the outer peripheral edge of the inner rotor side surface 17 or the outer rotor side surface 15, the dispersion liquid 37 obtained by dispersing particles of the fluororesin in the solvent can be applied to the inner rotor 6 and the outer rotor 8 without using masking tape or the like, so that the application work is easy.

Since the method for applying the dispersion liquid 37 obtained by dispersing particles of the fluororesin in the solvent is screen-printing, a coating layer of the crosslinked fluororesin 20 having a uniform thickness can be obtained without grinding or polishing the crosslinked fluororesin 20, so that the cost is low.

In FIG. 8A to FIG. 8D, separately performing the filling step of filling the opening 34 with the dispersion liquid 37 obtained by dispersing particles of the fluororesin in the solvent and the transferring step of transferring the dispersion liquid 37 with which the opening 34 has been filled has been described as an example, but filling the opening 34 with the dispersion liquid 37 and transferring the dispersion liquid 37 from the opening 34 may be performed by the squeegee 38 at one time.

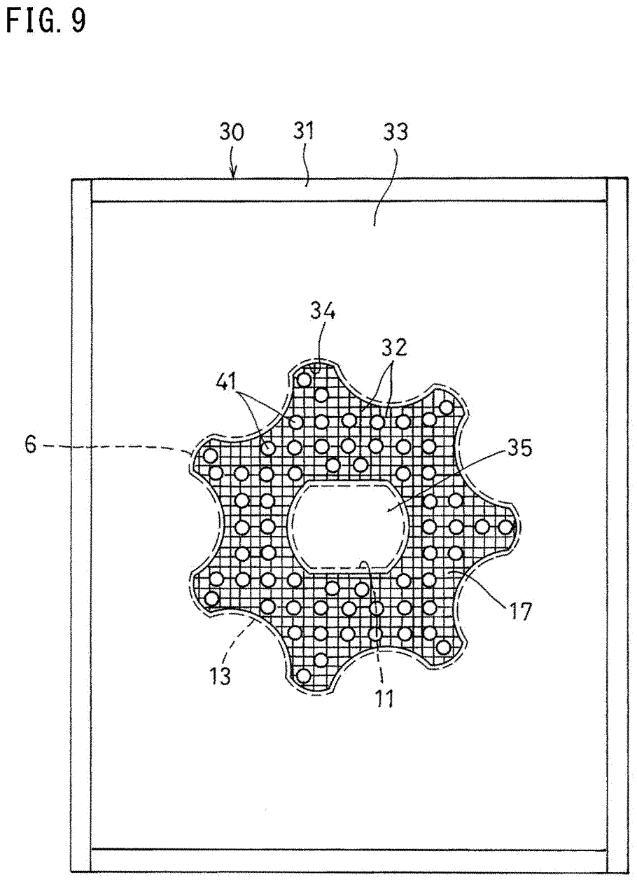

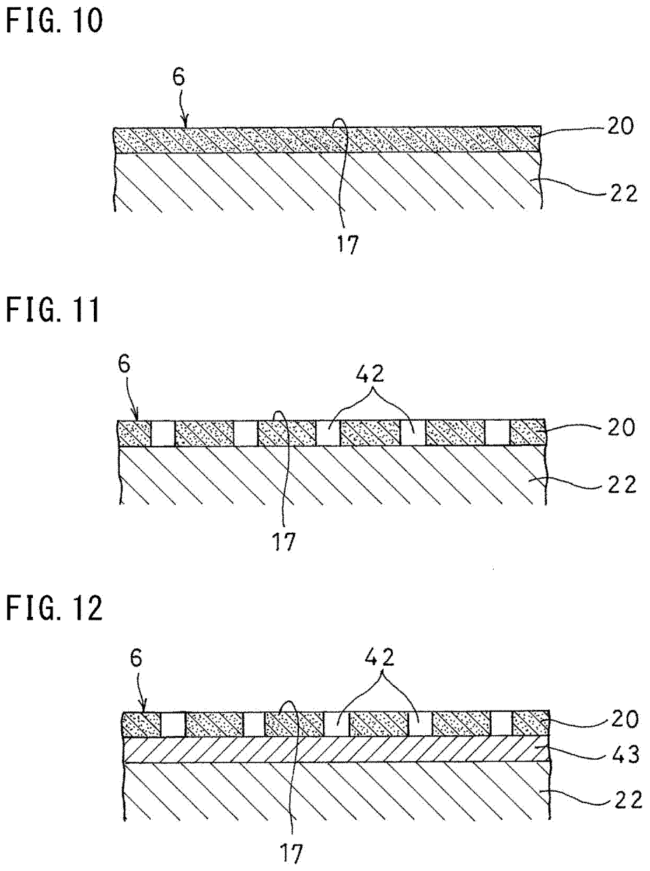

As shown in FIG. 9, as the screen plate 30, it is also possible to use a plate in which a plurality of non-printing regions 41 for blocking permeation of the dispersion liquid 37 are provided inside the opening 34. The non-printing regions 41 are minute mask portions which are interspersed and are each sized so as to fit in a circle having a diameter of less than 1 mm (preferably not greater than 500 μm, more preferably less than 300 μm). By doing so, as shown in FIG. 11, a plurality of through holes 42 corresponding to the non-printing regions 41 are formed in a coating layer of the crosslinked fluororesin 20, so that it is possible to hold lubricating oil in the through holes 42.

By doing so, since the lubricating oil is held in the plurality of through holes 42 of the coating layer of the crosslinked fluororesin 20, the friction reduction effect by the crosslinked fluororesin 20 and the lubrication effect by the lubricating oil are synergistically exerted, so that it is possible to significantly and effectively reduce the frictional resistance of the inner rotor side surface 17 and the outer rotor side surface 15. FIG. 10 shows a coating layer of the crosslinked fluororesin 20 formed without providing the non-printing regions 41.

As shown in FIG. 12, by providing an oil-impregnated plastic layer 43 on the rotor side surface in advance before screen-printing the dispersion liquid 37 on the rotor side surface, it is possible to expose the oil-impregnated plastic layer 43 through the through holes 42. By doing so, since the oil-impregnated plastic layer 43 has high lipophilicity, it is possible to very effectively hold the lubricating oil in the through holes 42 of the coating layer of the crosslinked fluororesin 20.

The material forming the oil-impregnated plastic layer 43 may include at least one of polyacetal, polyamide 6, polyamide 66, polybutylene terephthalate, or polyethylene as a base resin. The material forming the oil-impregnated plastic layer 43 may contain 5 to 15 volume % of the lubricating oil.

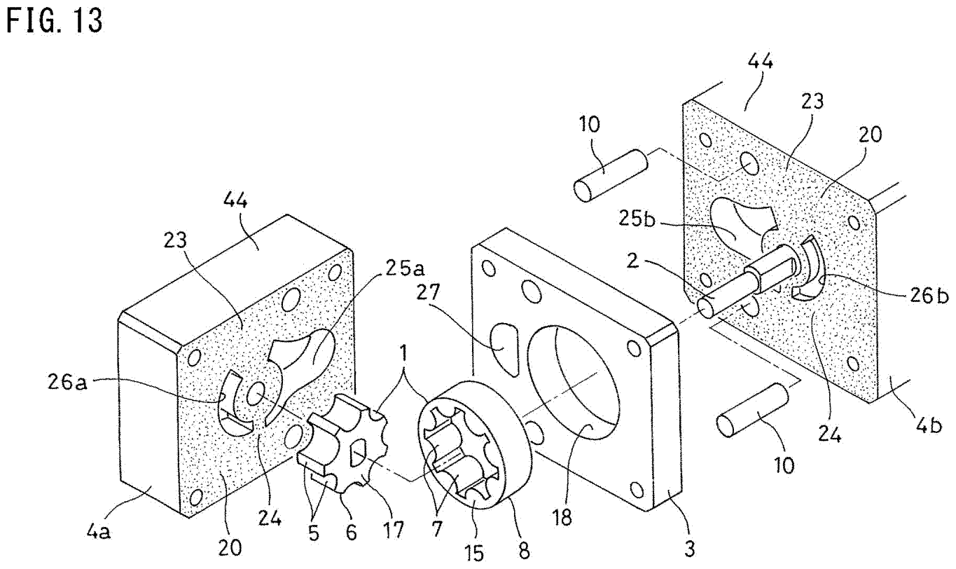

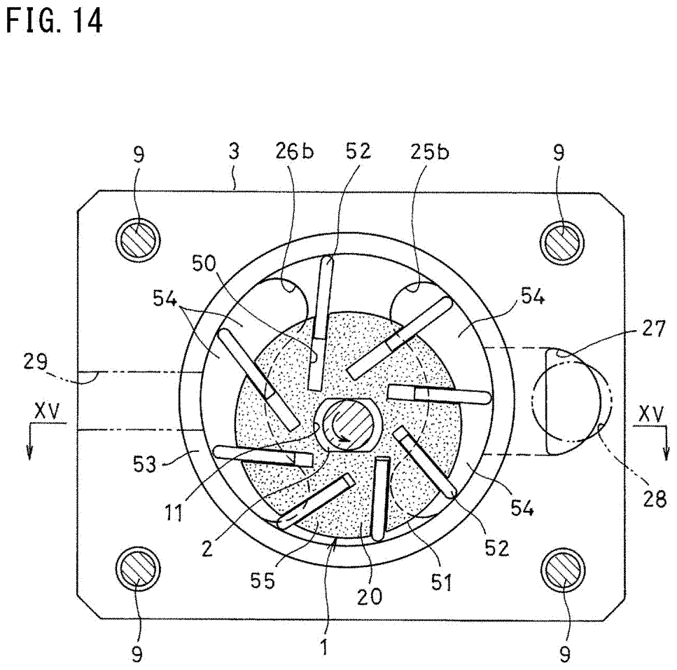

FIG. 13 shows a rotary pump, in which pump covers 4a and 4b obtained by a crosslinked fluororesin-coated pump cover manufacturing method are used, according to a second embodiment of the present disclosure. The second embodiment is different from the first embodiment only in that the part where a coating layer of the crosslinked fluororesin 20 is provided is changed from the inner rotor side surfaces 17 and the outer rotor side surfaces 15 to the sliding guide surfaces 24 of the first pump cover 4a and the second pump cover 4b, and the other configuration is the same as that of the first embodiment. Therefore, the portions corresponding to those of the first embodiment are designated by the same reference signs, and the description thereof is omitted.

A coating layer of the crosslinked fluororesin 20 is provided on the sliding guide surfaces 24 of the first pump cover 4a and the second pump cover 4b. Here, the first pump cover 4a and the second pump cover 4b each include a metal body 44 formed from an aluminum alloy or a steel material, and a coating layer of the crosslinked fluororesin 20 provided so as to coat the surface of the metal body 44, and the surface of the coating layer forms the sliding guide surface 24.

The first pump cover 4a can be manufactured by screen-printing the dispersion liquid 37 obtained by dispersing particles of the fluororesin in the solvent, on the sliding guide surface 24 of the first pump cover 4a by using a screen plate 30 having an opening 34 having a shape in which the opening 34 does not protrude from the outer peripheral edge of the sliding guide surface 24 of the first pump cover 4a to the radially outer side, then heating the first pump cover 4a to a temperature equal to or higher than the melting point of the fluororesin to bake the fluororesin on the sliding guide surface 24 of the first pump cover 4a, and then irradiating the fluororesin with radiation to crosslink the fluororesin. The same applies to the second pump cover 4b.

When the first pump cover 4a and the second pump cover 4b are manufactured as described above, since the sliding guide surfaces 24 of the first pump cover 4a and the second pump cover 4b are coated with the crosslinked fluororesin 20, even when the side clearances of the inner rotor 6 and the outer rotor 8 are set to be very small, it is possible to prevent seizure of the inner rotor 6 and the outer rotor 8 over a long period of time.

Since the dispersion liquid 37 obtained by dispersing particles of the fluororesin in the solvent is screen-printed by using the screen plate 30 having the opening 34 having a shape in which the opening 34 does not protrude from the outer peripheral edges of the sliding guide surfaces 24 of the first pump cover 4a and the second pump cover 4b, the dispersion liquid 37 obtained by dispersing particles of the fluororesin in the solvent can be applied to the sliding guide surfaces 24 of the first pump cover 4a and the second pump cover 4b without using masking tape or the like, so that the application work is easy.

Since the method for applying the dispersion liquid 37 obtained by dispersing particles of the fluororesin in the solvent is screen-printing, a coating layer of the crosslinked fluororesin 20 having a uniform thickness can be obtained without grinding or polishing the crosslinked fluororesin 20, so that the cost is low.

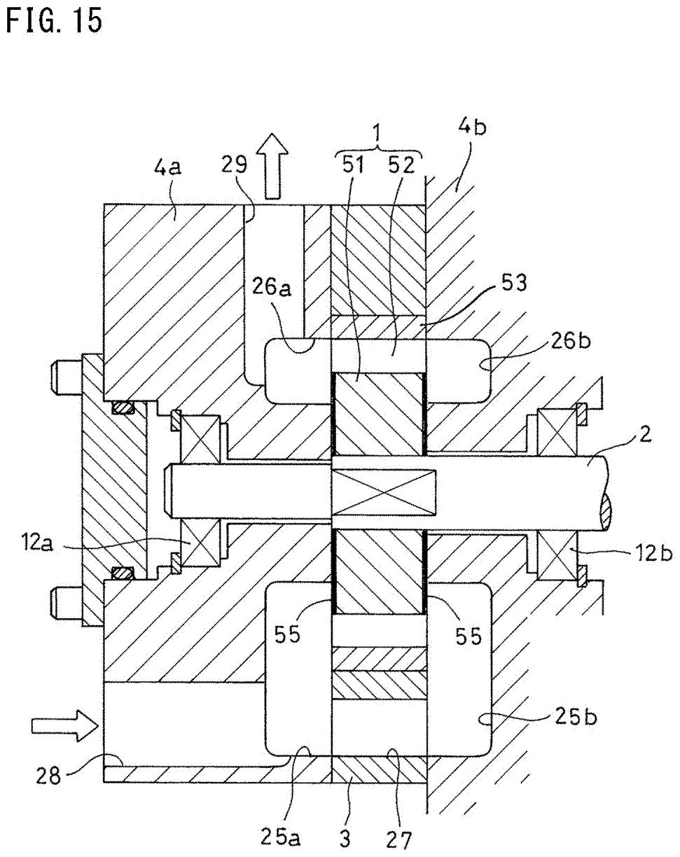

FIG. 14 to FIG. 16 show a rotary pump, in which a pump rotor 1 obtained by a manufacturing method for a crosslinked fluororesin-coated pump rotor 1 is used, according to a third embodiment of the present disclosure. The third embodiment is different from the first embodiment only in the configuration of the pump rotor 1, and the other configuration is the same as that of the first embodiment. Therefore, the portions corresponding to those of the first embodiment are designated by the same reference signs, and the description thereof is omitted.

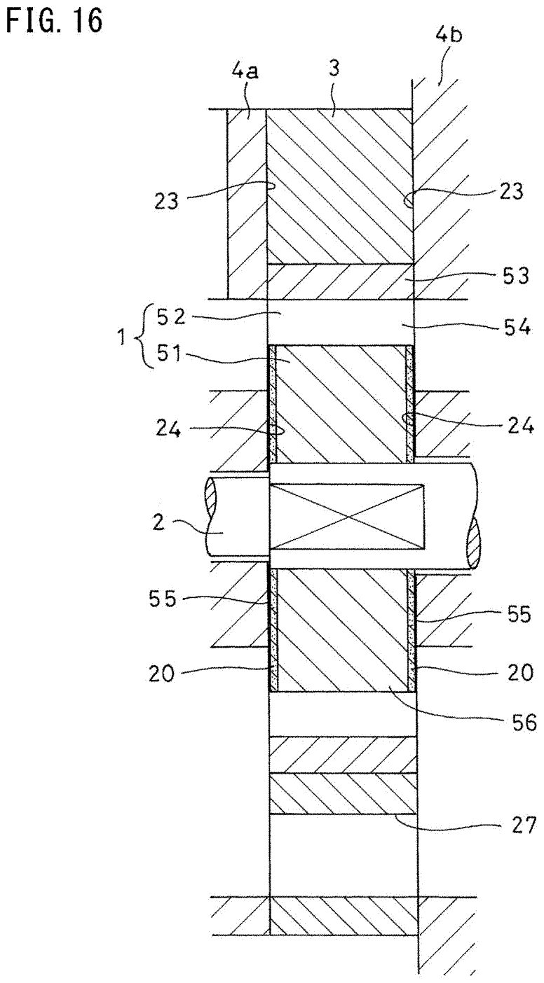

As shown in FIG. 14 and FIG. 15, the pump rotor 1 includes a rotor body 51 having a plurality of vane housing grooves 50 on the outer periphery thereof, and a plurality of vanes 52 which are housed in the plurality of vane housing grooves 50, respectively, so as to be slidable in the radial direction. The radially outer end of each vane 52 is in sliding contact with the inner periphery of a cam ring 53 which is provided in the housing body 3. A plurality of chambers 54 (spaces for containing fluid) defined by the vanes 52 are formed between the outer periphery of the rotor body 51 and the inner periphery of the cam ring 53. The inner periphery of the cam ring 53 is formed such that the volume of each chamber 54 changes as the rotor body 51 rotates, and fluid discharge action by reduction of the volumes of the chambers 54 and fluid suction action by gradual increase of the volumes of the chambers 54 occur.

As shown in FIG. 16, the rotor body 51 has a pair of flat rotor side surfaces 55 which are formed on both sides in the axial direction of the rotor body 51 so as to face opposite to each other in the axial direction. A coating layer of the crosslinked fluororesin 20 is provided on each rotor side surface 55. Here, the rotor body 51 includes a sintered metal body 56 and a coating layer of the crosslinked fluororesin 20 provided so as to coat the surface of the sintered metal body 56, and the surface of the coating layer forms the rotor side surfaces 55.

Similarly to the first embodiment, the rotor body 51 can be manufactured by screen-printing the dispersion liquid 37 obtained by dispersing particles of the fluororesin in the solvent, on each rotor side surface 55 by using a screen plate 30 having an opening 34 having a shape in which the opening 34 does not protrude from the outer peripheral edge of the rotor side surface 55 to the radially outer side, then heating the rotor body 51 to a temperature equal to or higher than the melting point of the fluororesin to bake the fluororesin on the rotor side surface 55, and then irradiating the fluororesin with radiation to crosslink the fluororesin.

A coating layer of the crosslinked fluororesin 20 may also be provided on the side surfaces (side surfaces in sliding contact with the sliding guide surfaces 24) on both sides in the axial direction of each vane 52. By doing so, the sliding resistance between the vanes 52 and the pump covers 4a and 4b can also be reduced, so that it is possible to effectively improve the pump efficiency.

### REFERENCE SIGNS LIST

1 pump rotor

2 rotation shaft

3 housing body

4a first pump cover

4b second pump cover

5 external teeth

6 inner rotor

7 internal teeth

8 outer rotor

9 bolt

10 knock pin

11 shaft hole

12a first bearing

12b second bearing

13 outer peripheral surface

14 inner peripheral surface

15 outer rotor side surface

16 outer peripheral surface

17 inner rotor side surface

18 inner peripheral surface

19 chamber

20 crosslinked fluororesin

21 sintered metal body

22 sintered metal body

23 mating surface

24 sliding guide surface

25a first suction port

25b second suction port

26a first discharge port

26b second discharge port

27 communication passage

28 suction port

29 discharge port

30 screen plate

31 frame body

32 screen mesh

33 mask portion

34 opening

35 mask portion

36 scraper

37 dispersion liquid

38 squeegee

39 auxiliary surface

40 jig

41 non-printing region

42 through hole

43 oil-impregnated plastic layer

44 metal body

50 vane housing groove

51 rotor body

52 vane

53 cam ring

54 chamber

55 rotor side surface

56 sintered metal body

w width of band-shaped region where mask portion overlaps rotor side surface

1. A crosslinked fluororesin-coated pump rotor manufacturing method for manufacturing a pump rotor having flat rotor side surfaces and provided with a coating layer of a crosslinked fluororesin on each rotor side surface, the method comprising:
screen-printing a dispersion liquid obtained by dispersing particles of a fluororesin in a solvent, on the rotor side surface by using a screen plate having an opening having a shape in which the opening does not protrude from an outer peripheral edge of the rotor side surface;
then heating the pump rotor to a temperature equal to or higher than a melting point of the fluororesin to bake the fluororesin on the rotor side surface; and
then irradiating the fluororesin with radiation to crosslink the fluororesin.

2. The crosslinked fluororesin-coated pump rotor manufacturing method according to claim 1, wherein a plurality of through holes for holding oil are formed in the coating layer of the crosslinked fluororesin by using a plate in which a plurality of non printing regions for blocking permeation of the dispersion liquid are provided inside the opening, as the screen plate. The crosslinked fluororesin-coated pump rotor manufacturing method according to claim 2, wherein an oil-impregnated plastic layer is exposed through the through holes by providing the oil-impregnated plastic layer on the rotor side surface in advance before screen-printing the dispersion liquid on the rotor side surface.

4. A crosslinked fluororesin-coated pump rotor having flat rotor side surfaces and provided with a coating layer of a crosslinked fluororesin on each rotor side surface, wherein
a plurality of through holes for holding oil are foamed in the coating layer of the crosslinked fluororesin.

5. The crosslinked fluororesin-coated pump rotor according to claim 4 wherein an oil-impregnated plastic layer is provided as a base for the coating layer of the crosslinked fluororesin and exposed through the through holes.

6. A crosslinked fluororesin-coated pump cover manufacturing method for manufacturing a pump cover having a flat sliding guide surface for sliding and guiding a pump rotor and provided with a coating layer of a crosslinked fluororesin on the sliding guide surface, the method comprising:
screen-printing a dispersion liquid obtained by dispersing particles of a fluororesin in a solvent, on the sliding guide surface by using a screen plate having an opening having a shape in which the opening does not protrude from an outer peripheral edge of the sliding guide surface;
then heating the pump cover to a temperature equal to or higher than a melting point of the fluororesin to bake the fluororesin on the sliding guide surface; and
then irradiating the fluororesin with radiation to crosslink the fluororesin.

7. The crosslinked fluororesin-coated pump cover manufacturing method according to claim 6, wherein a plurality of through holes for holding oil are formed in the coating layer of the crosslinked fluororesin by using a plate in which a plurality of non-printing regions for blocking permeation of the dispersion liquid are provided inside the opening, as the screen plate.

8. The crosslinked fluororesin-coated pump cover manufacturing method according to claim 7, wherein an oil-impregnated plastic layer is exposed through the through holes by providing the oil-impregnated plastic layer on the sliding guide surface in advance before screen-printing the dispersion liquid on the sliding guide surface.

9. A crosslinked fluororesin-coated pump cover having a flat sliding guide surface for sliding and guiding a pump rotor and provided with a coating layer of a crosslinked fluororesin on the sliding guide surface, wherein
a plurality of through holes for holding oil are formed in the coating layer of the crosslinked fluororesin.

10. The crosslinked fluororesin-coated pump cover according to claim 9, wherein an oil-impregnated plastic layer is provided as a base for the coating layer of the crosslinked fluororesin and exposed through the through holes.
